(19) United States
(12) Patent Application Publication
(10) Pub. No.: US 2007/0275275 A1
(43) Pub. Date: Nov. 29, 2007

(54) FUEL CELL ANODE PURGE SYSTEMS AND METHODS

(76) Inventor: Mesa Scharf, Redmond, OR (US)

Correspondence Address: KOLISCH HARTWELL, P.C., 520 SW YAMHILL STREET, Suite 200, PORTLAND, OR, 97204, US

(21) Appl. No.: 11/747,763

(22) Filed: May 11, 2007

Related U.S. Application Data
(60) Provisional application No. 60/808,027, filed on May 23, 2006.

(51) Int. Cl. H01M 8/00; H01M 16/00; H01M 8/04

(52) U.S. Cl. 429/13; 429/9; 429/22

(57) ABSTRACT

Systems and methods of purging liquid from an anode flow field of a fuel cell having an anode region and a cathode region. A fuel cell is electrically coupled to an energy consuming device that applies a load to the fuel cell. A fuel stream is delivered to the anode region, and an oxidant stream to the cathode region, thereby causing an anode purge stream to be emitted from the anode region, and causing the fuel cell to generate an electrical output that satisfies at least a portion of the electrical load. The fuel cell is then electrically isolated from the applied load for a temporary period of time without substantially altering the flow rate of the fuel stream delivered to the anode region. The period of time is sufficient to cause the flow rate of the purge stream emitted from the anode region to increase in magnitude to expel from the anode region a substantial portion of any liquid that has collected in the anode flow field.

### CROSS-REFERENCE TO RELATED APPLICATION

This application claims priority under 35 U.S.C. §119(e) to U.S. Provisional Patent Application Ser. No. 60/808,027, which is entitled “Fuel Cell Anode Purge Systems and Methods,” was filed on May 23, 2006, and the entire disclosure of which is herein incorporated by reference for all purposes.

### FIELD OF THE DISCLOSURE

The present disclosure is directed to fuel cell systems, and more particularly to systems and methods for selectively purging the anode region of a fuel cell or fuel cell stack.

### BACKGROUND OF THE DISCLOSURE

Fuel cells are electrochemical devices that produce an electric current from a fuel, which typically is a proton source, and an oxidant. Many conventional fuel cells utilize hydrogen gas as the proton source and oxygen, air, or oxygen-enriched air as the oxidant. Others, which are referred to as direct methanol fuel cells, utilize methanol and water as fuel. Fuel cell stacks typically include many fuels cells that are fluidly and electrically coupled together between common end plates. Each fuel cell includes anode and cathode regions that are separated by an electrolytic membrane or other electrolytic barrier. In fuel cells that utilize hydrogen gas as a fuel, hydrogen gas is delivered to the anode region, and oxygen gas is delivered to the cathode region. Protons from the hydrogen gas are drawn through the electrolytic membrane to the cathode region, where water is formed. In direct methanol fuel cells, methanol and water are delivered to the anode region, where the methanol is oxidized in the presence of water to produce carbon dioxide, protons and electrons. While protons may pass through the membranes, electrons cannot. Instead, the liberated electrons travel through an external circuit to form an electric current.

Conventionally, the anode and cathode regions of fuel cells are periodically purged. One reason for purging the regions is to remove accumulated gases from the regions, especially gases that are not utilized as reactants in the particular region. As illustrative, non-exclusive examples, water vapor and nitrogen gas may accumulate in the cathode region of a fuel cell, and in the case of a direct methanol fuel cell, carbon dioxide may also accumulate in the anode region. Another reason for periodically purging one or both of the regions of a fuel cell is to remove liquid water that may have accumulated in the anode and/or cathode regions. Many fuel cells require some amount of water to be present in the anode and/or cathode regions to maintain proper hydration of the fuel cell's electrolytic membrane. However, too much water may impair the operation of the fuel cell, and is referred to as flooding of the fuel cell. Many fuel cells also utilize narrow channels, or flow fields, that define gas passages on each side of the electrolytic membrane, with these flow fields typically being formed in supporting plates on opposed sides of the electrolytic membrane. Liquid, such as water droplets, may form and/or collect in the flow fields and block the flow of gases therethrough, thereby impairing the operation of the fuel cell. Periodic purging may be used to remove these liquid droplets, provided that the purge has sufficient force to exhaust these droplets.

### BRIEF DESCRIPTION OF THE DRAWINGS

FIG. 1 is a schematic view of an illustrative fuel cell system that includes a fuel cell stack according to the present disclosure.

FIG. 2 is a schematic view of an illustrative fuel cell, such as may be included in a fuel cell stack according to the present disclosure.

FIG. 3 is a schematic fragmentary view of a plurality of fuel cells, as may be used in fuel cell stacks according to the present disclosure.

FIG. 4 is an exploded schematic view of a fuel cell, as may be used in fuel cell stacks according to the present disclosure.

FIG. 5 is a schematic view of another illustrative fuel cell system that includes a fuel cell stack and purge system according to the present disclosure.

FIG. 6 is a fragmentary schematic view of an anode region purge system according to the present disclosure.

### DETAILED DESCRIPTION AND BEST MODE OF THE DISCLOSURE

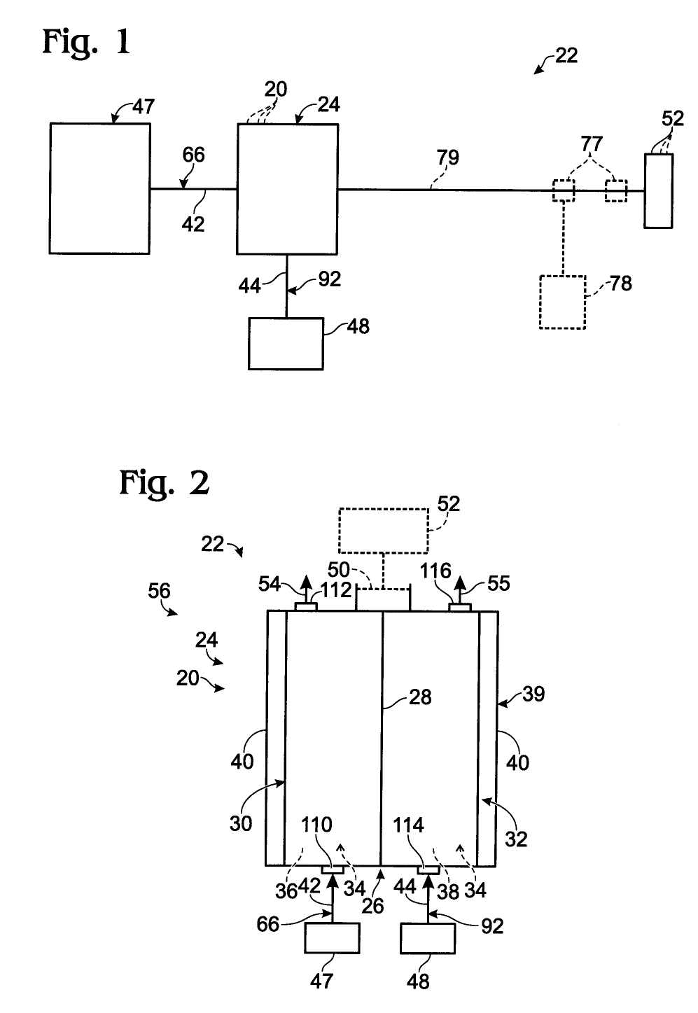

An example of a fuel cell system is schematically illustrated in FIG. 1 and generally indicated at 22. As discussed in more detail herein, system 22 may include at least one fuel cell stack 24 having one or more fuel cells 20. Each fuel cell is adapted to selectively consume a fuel 42 and an oxidant 44 to generate a power output, or electrical output, having a nominal voltage when a load is applied to the fuel cell stack by an energy consuming device 52. The one or more fuel cells 20 in the fuel cell stack 24 may thus individually or collectively generate a power output, or electrical output, 79 that satisfies at least a portion of the applied load.

Fuel 42 may include any suitable reactant, or feedstock, for producing an electric current in a fuel cell stack 24 when the fuel and an oxidant 44 are delivered to the anode and cathode regions, respectively, of the fuel cell(s) 20 in the stack. Fuel 42 may, but is not required to be, a proton source. In the following discussion, fuel 42 will be described as being hydrogen gas, and oxidant 44 will be described as being air, but it is within the scope of the present disclosure that other suitable fuels and/or oxidants may be used to produce a power output, or electrical output, 79 from fuel cell stack 24. For example, other suitable oxidants include oxygen-enriched air streams, and streams of pure or substantially pure oxygen gas. Fuel cell system 22 may also be referred to as an energy-producing system. Illustrative examples of suitable fuels other than hydrogen gas include methanol, methane, and carbon monoxide.

As schematically illustrated in FIG. 1, fuel cell system 22 includes a source, or supply, 47 of fuel (e.g. hydrogen gas) and a source, or supply, 48 of oxidant (e.g. air containing oxygen gas). The fuel and oxidant sources are adapted to deliver fuel stream 66 and oxidant stream 92 to the fuel cell stack 24. For example, hydrogen gas 42 and oxygen gas 44 may be delivered to the fuel cell stack via any suitable mechanism from fuel source 47 and oxidant source 48, which may have any suitable construction and/or configuration. Fuel cell stack 24 produces from these streams a power output, which is schematically represented at 79. Also shown in dashed lines in FIG. 1 is at least one energy-consuming device 52. Device 52 graphically represents one or more devices that are adapted to apply a load to the fuel cell system, with the system being adapted to satisfy this load with the power output, or electrical output, produced by the fuel cell stack. The fuel cell system may include additional components that are not specifically illustrated in the schematic figures, such as air delivery systems, heat exchangers, sensors, controllers, flow-regulating devices, fuel and/or feedstock delivery assemblies, heating assemblies, cooling assemblies, and the like.

The at least one energy-consuming device 52 may be electrically coupled to the fuel cell system 22, such as to the fuel cell stack 24 and/or to one or more optional energy-storage devices 78 associated with the stack. Device 52 applies a load to the fuel cell system 22 and draws an electric current from the system to satisfy the load. This load may be referred to as an applied load, and may include thermal and/or electrical load(s). It is within the scope of the present disclosure that the applied load may be satisfied by the fuel cell stack, the energy-storage device, or both the fuel cell stack and the energy-storage device. Illustrative examples of devices 52 include motor vehicles, recreational vehicles, boats and other sea craft, and any combination of one or more households, residences, commercial offices or buildings, neighborhoods, tools, lights and lighting assemblies, appliances, computers, industrial equipment, signaling and communications equipment, radios, electrically powered components on boats, recreational vehicles or other vehicles, battery chargers and even the balance-of-plant electrical requirements for the fuel cell system 22 of which fuel cell stack 24 forms a part.

FIG. 1 schematically depicts that fuel cell system 22 may, but is not required to, include at least one energy-storage device 78. Device 78, when included, may be adapted to store at least a portion of the electrical output, or power output, 79 from the fuel cell stack 24. An illustrative example of a suitable energy-storage device 78 is a battery, but others may be used. Illustrative, non-exclusive examples of other suitable energy-storage devices that may be used in place of or in combination with one or more batteries include capacitors and ultracapacitors or supercapacitors. Another illustrative example is a fly wheel. Energy-storage device 78 may be configured to provide power to energy-consuming device 52, such as to satisfy an applied load therefrom, when the fuel cell stack is not able to completely satisfy the applied load, or is not able to satisfy any portion of the load. Energy-storage device 78 may additionally or alternatively be used to power the fuel cell system 22 during start-up of the system. The energy-storage device 78 may be rechargeable. For example, the energy-storage device may be configured to be selectively recharged by the electrical output 79 of fuel cell system 22, and/or the electrical output of another power source, such as a utility grid, another fuel cell system, a solar or hydroelectric source, or any other suitable power source.

As indicated in dashed lines at 77 in FIG. 1, the fuel cell system may, but is not required to, include at least one power management module 77. Power management module 77 includes any suitable structure for conditioning or otherwise regulating the electrical output produced by the fuel cell system, such as for delivery to energy-consuming device 52. Power management module 77 may include such illustrative structure as buck and/or boost converters, inverters, power filters, relays, and the like.

The fuel cell stacks of the present disclosure may utilize any suitable type of fuel cell, including but not limited to fuel cells that receive hydrogen gas and oxygen gas as proton sources and oxidants. Illustrative examples of types of fuel cells include proton exchange membrane (PEM) fuel cells, alkaline fuel cells, solid oxide fuel cells, molten carbonate fuel cells, phosphoric acid fuel cells, direct methanol fuel cells, and the like. For the purpose of illustration, an exemplary fuel cell 20 in the form of a PEM fuel cell is schematically illustrated in FIG. 2.

Proton exchange membrane fuel cells typically utilize a membrane-electrode assembly 26 consisting of an ion exchange, or electrolytic, membrane 28 located between an anode region 30 and a cathode region 32. Each region 30 and 32 includes an electrode 34, namely an anode 36 and a cathode 38, respectively. Each region 30 and 32 also includes a support 39, such as a supporting plate 40. Support 39 may form a portion of the bipolar plate assemblies that are discussed in more detail herein. The supporting plates 40 of fuel cells 20 carry, or conduct, the relative voltage potentials produced by the fuel cells.

In operation, hydrogen gas 42 from supply 47 is delivered to the anode region via fuel stream 66, and air 44 from supply 48 is delivered to the cathode region via oxidant stream 92. Hydrogen and oxygen gases may be delivered to the respective regions of the fuel cell via any suitable mechanism from respective sources 47 and 48. Illustrative, non-exclusive examples of suitable sources 47 for hydrogen gas 42 include a pressurized tank, metal hydride bed or other suitable hydrogen storage device, a chemical hydride (such as a solution of sodium borohydride), and/or a hydrogen-producing fuel processing system or other hydrogen generation assembly that produces a stream containing pure or at least substantially pure hydrogen gas from at least one feedstock. Non-exclusive examples of suitable fuel processors and fuel processing assemblies (including illustrative non-exclusive examples of components and configurations therefore) for producing streams of at least substantially pure hydrogen gas are disclosed in U.S. Pat. Nos. 6,319,306, 6,221,117, 5,997,594, 5,861,137, and U.S. Patent Application Publication Nos. 2001/0045061, 2003/0192251, 2003/0223926, and 2006/0090397. The complete disclosures of the above-identified patents and patent applications are hereby incorporated by reference for all purposes. Illustrative, non-exclusive examples of suitable sources 48 of oxygen gas 44 include a pressurized tank of oxygen gas, oxygen-enriched air, or air, or a fan, compressor, blower or other device for directing air to the cathode regions of the fuel cells in the fuel cell stack. Once delivered to the anode and cathode regions, the fuel stream may be received into the anode region via anode inlet 110, and the oxidant stream may be received into the cathode region via cathode inlet 114.

Once inside a fuel cell, the hydrogen gas and oxygen gas typically react with one another via an oxidation-reduction reaction. Although membrane 28 restricts the passage of a hydrogen molecule, it will permit a hydrogen ion (proton) to pass through it, largely due to the ionic conductivity of the membrane. The free energy of the oxidation-reduction reaction drives the proton from the hydrogen gas through the ion exchange membrane. As membrane 28 also tends not to be electrically conductive, an external circuit 50 is the lowest energy path for the remaining electron, and is schematically illustrated in FIG. 2. In cathode region 32, electrons from the external circuit and protons from the membrane combine with oxygen to produce water and heat.

FIG. 2 also schematically illustrates an anode purge stream, or exhaust stream, 54, which is emitted from the anode region through an anode outlet 112, and a cathode purge stream, or air exhaust stream, 55, which is emitted from the cathode region through a cathode outlet 116. The anode purge stream 54 may contain unreacted hydrogen gas, as well as other components, such as nitrogen gas, water, and other gases that are present in the hydrogen gas or other fuel stream that is delivered to the anode region. The cathode purge stream 55, which may be at least partially, if not substantially, depleted of oxygen gas, may also include water.

Fuel cell stack 24 may include a common hydrogen (or other reactant/fuel) feed, air intake, and stack purge and exhaust streams, and accordingly will typically include suitable fluid manifolds and/or conduits to deliver the associated streams to, and collect the streams from, each of the one or more individual fuel cells. Similarly, any suitable mechanism may be used for selectively purging the anode and/or cathode regions, 30 and 32. It is also within the scope of the present disclosure that the hydrogen gas stream that is delivered to the anode region as a fuel stream may be recycled (via any suitable mechanism and/or via a suitable recycle conduit from the anode region) to reduce the amount of hydrogen gas that is wasted or otherwise exhausted in anode purge stream 54. As an illustrative, non-exclusive example, the hydrogen gas in the anode region may be recycled for redelivery to the anode region via a recycle pump and an associated recycle conduit. In such an embodiment, the recycle pump may draw hydrogen gas from the anode region of a fuel cell (or fuel cell stack) and redeliver at least some of the recycled hydrogen gas via the recycle conduit to the anode region of the fuel cell (and/or a different fuel cell of the same or a different fuel cell stack).

In practice, fuel cell stack 24 may include a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load. This net flow of electrons produces an electric current that may be used to satisfy an applied load, such as from at least one of an energy-consuming device 52 and the fuel cell system 22.

FIG. 3 shows a schematic representation of a fragmentary portion of an illustrative, nonexclusive example of a fuel cell stack 24. As shown, the illustrated portion includes a plurality of fuel cells, including fuel cells 16′ and 16″. Fuel cell 16′ includes a membrane-electrode assembly (MEA) 56 positioned between a pair of bipolar plate assemblies 57, such as assemblies 58 and 60. Similarly, fuel cell 16″ includes an MEA 62 positioned between a pair of bipolar plate assemblies 57, such as bipolar plate assemblies 60 and 64. Therefore, bipolar plate assembly 60 is operatively interposed between adjacently situated MEAs 56 and 62. Additional fuel cells may be serially connected in similar fashion, wherein a bipolar plate may be operatively interposed between adjacent MEAs. The phrase “working cell” is used herein to describe fuel cells, such as cells 16′ and 16″, that are configured to produce an electric current, or electrical output, from fuel and oxidant and which typically include an MEA positioned between bipolar plate assemblies.

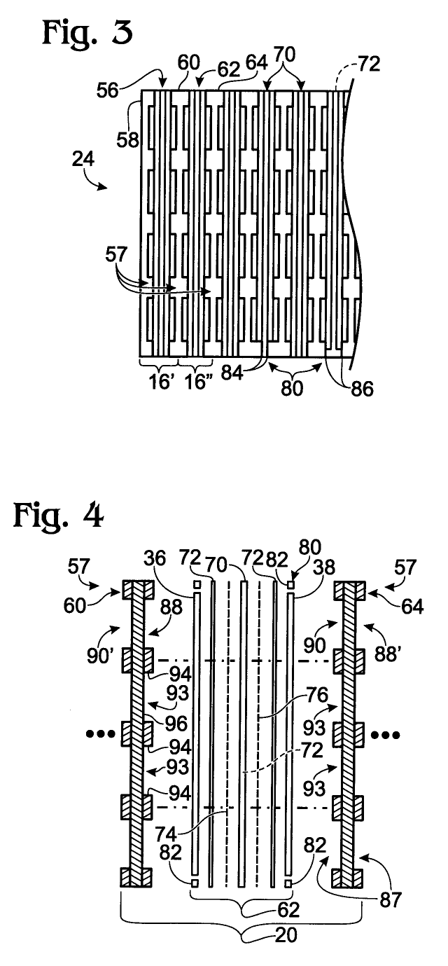

FIG. 4 shows an exploded schematic view of an illustrative fuel cell, or fuel cell assembly, 20, which as discussed includes a membrane-electrode assembly (MEA) 62 positioned between bipolar plate assemblies 60 and 64. MEA 62 includes anode 36, cathode 38, and an electron barrier 70 that is positioned therebetween. Electron barrier 70 may include any suitable structure and/or composition that enables protons to pass therethrough and yet retards the passage of electrons to bias the electrons to an external circuit. As an illustrative, non-exclusive example, barrier 70 may include a membrane-supported electrolyte that is capable of blocking electrons, while allowing protons to pass. For example, in PEM fuel cells, electron barrier 70 may be a membrane that is configured to conduct hydrogen cations (protons) and inhibit electron flow, and as such may also be described as an ion exchange membrane. In an alkaline fuel cell, electron barrier 70 may include an aqueous alkaline solution or membrane. For phosphoric acid fuel cells, electron barrier 70 may include a phosphoric acid solution (neat or diluted) or membrane.

For at least PEM fuel cells, the electrodes, such as anode 36 and cathode 38, may be constructed of a porous, electrically conductive material, such as carbon fiber paper, carbon fiber cloth, or other suitable materials. Catalysts 74 and 76 are schematically depicted as being disposed between the electrodes and the electron barrier. Such catalysts facilitate electrochemical activity and may be embedded into barrier 70, such as into membrane 28. Fuel cell 20 will typically also include a gas diffusion layer 72 between the electrodes and catalysts 74 and 76. For example, layer 72 may be formed on the surface of the electrodes and/or the catalysts and may be formed from a suitable gas diffusing material, such as a thin film of powdered carbon. Layer 72 is typically treated to be hydrophobic to resist the coating of the gas diffusion layers by water present in the anode and cathode regions, which may prevent gas from flowing therethrough.

A fluid seal may be formed between adjacent bipolar plate assemblies. As such, a variety of sealing materials or sealing mechanisms 80 may be used at or near the perimeters of the bipolar plate assemblies. An illustrative, non-exclusive example of a suitable sealing mechanism 80 is a gasket 82 that extends between the outer perimeters of the bipolar plate assemblies and barrier 70. Other illustrative examples of suitable sealing mechanisms 80 are schematically illustrated in the lower portion of FIG. 3 and include bipolar plate assemblies with projecting flanges 84, which extend into contact with barrier 70, and/or a barrier 70 with projecting flanges 86 that extend into contact with the bipolar plate assemblies. In some embodiments, such as graphically depicted in FIG. 4, the fuel cells may include a compressible region between adjacent bipolar plate assemblies, with gaskets 82 and barrier 70 being examples of suitable compressible regions that permit the cells, and thus the stack, to be more tolerant and able to withstand external forces applied thereto.

As shown in FIG. 4, bipolar plate assemblies 60 and 64 may extend along opposite sides of MEA 62 so as to provide structural support to the MEA. Such an arrangement also allows the bipolar plate assemblies to provide a current path between adjacently situated MEAs. Bipolar plate assemblies 60 and 64 are shown with somewhat schematically illustrated flow fields 87, namely anode flow fields 88 and cathode flow fields 90. The anode flow field 88 and cathode flow field 90 may be configured to transport fluids through the various portions of the anode region and cathode region, respectively. For example, the anode flow field 88 may be configured to transport fuel, such as hydrogen gas, to the anode. The anode flow field may also be configured to transport unreacted fuel, as well as other components (e.g. nitrogen gas, water, and other gases that are present in the hydrogen gas or other fuel stream that is delivered to the anode region) to the anode outlet where they can be emitted from the anode region in anode purge stream 54. Similarly, the cathode flow field 90 may be configured to transport oxidant, such as oxygen gas, to the cathode, and to transport excess air and water to the cathode outlet, where they may be emitted from the cathode region in cathode purge stream 55.

The flow fields typically include one or more channels 93 that are at least partially defined by opposing sidewalls 94 and a bottom, or lower surface 96. Flow fields 88 and 90 have been schematically illustrated in FIG. 4 and may have a variety of shapes and configurations. Similarly, the channels 93 in a given flow field may be continuous, discontinuous, or may contain a mix of continuous and discontinuous channels. Examples of a variety of flow field configurations are shown in U.S. Pat. Nos. 4,214,969, 5,300,370, and 5,879,826, the complete disclosures of which are herein incorporated by reference.

As also shown in FIG. 4, the bipolar plate assemblies may include both anode and cathode flow fields, with the flow fields being generally opposed to each other on opposite faces of the bipolar plate assemblies. This construction enables a single bipolar plate assembly 57 to provide structural support and contain the flow fields for a pair of adjacent MEAs. For example, as illustrated in FIG. 4, bipolar plate assembly 60 includes anode flow field 88 and a cathode flow field 90′, and bipolar plate assembly 64 includes cathode flow field 90 and an anode flow field 88′. Although many, if not most or even all, of the bipolar plate assemblies within a stack will have the same or a similar construction and application, it is within the scope of the disclosure that not every bipolar plate assembly within stack 24 contains the same structure, supports a pair of MEAs, or contains oppositely facing flow fields.

Fuel cell systems according to the present disclosure may, but are not required to, also include a control system with at least one controller that selectively regulates the operation of the fuel cell system, such as by monitoring and/or controlling the operating state of various components and/or various operating parameters of the fuel cell system. Accordingly, the control system may include or be in communication with any suitable number and type of sensors for measuring and/or monitoring various operating parameters (such as temperature, pressure, flow rate, electrical output, current, voltage, capacity, composition, etc.) and communicating these values to the controller. The control system may also include any suitable number and type of communication links for receiving inputs and for sending command signals, such as to control or otherwise adjust the operating state of the fuel cell system, or selected components thereof. The controller may have any suitable configuration, and may include software and hardware components.

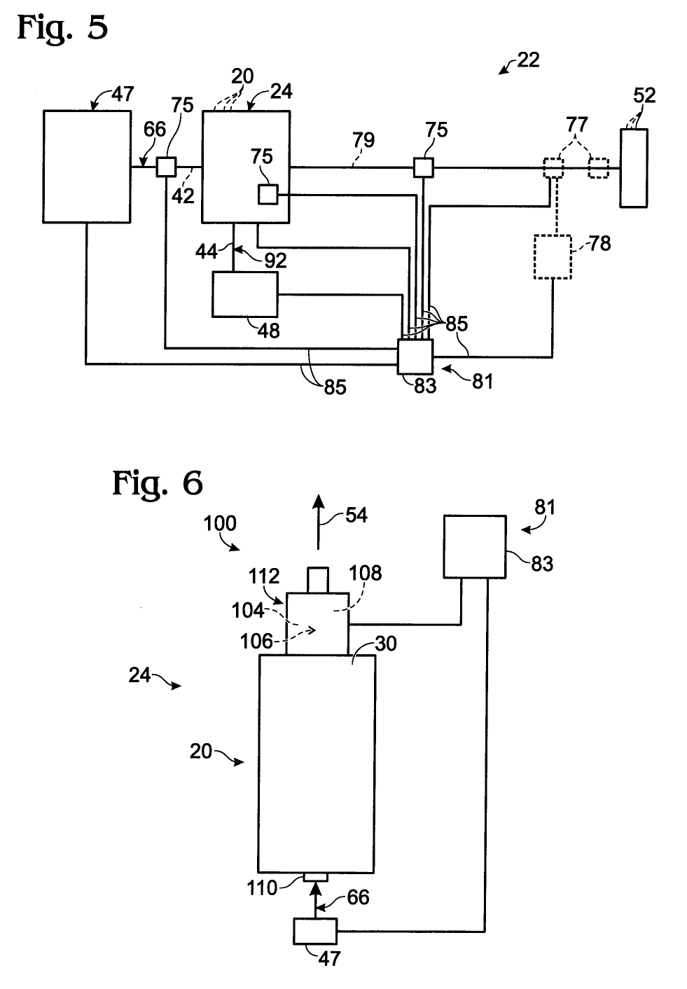

For the purpose of schematic illustration, a control system 81 with a controller 83 is shown in FIG. 5 in communication, via communication links 85 and sensors 75, with fuel cell stack 24, the sources 47 and 48 of hydrogen and oxygen gas, hydrogen stream 66, power output 79, power management module 77, and energy-storage device 78. However, other configurations may be utilized (including more or less one- or two-way communication links with various portions of the fuel cell system) without departing from the scope of the present disclosure.

In the schematic example of a PEM fuel cell shown in FIG. 2, anode and cathode purge streams were indicated at 54 and 55. Periodically, it may be necessary or desirable to purge fluids from the anode and/or cathode regions of the discussed PEM fuel cell, as well as other fuel cells. As indicated previously, to simplify the following discussion, it will refer to the selective purging of the anode region of a PEM fuel cell, or fuel cell stack. However, it is within the scope of the present disclosure that the purge systems and methods discussed herein may be utilized with other types of fuel cells and fuel cell stacks. As discussed, the fuel cells of a fuel cell stack may be in fluid communication with each other, such as via fluid conduits that interconnect the fuel cells of a fuel cell stack to selectively deliver fluids thereto and/or to selectively remove fluids therefrom. Accordingly, while the following discussion will refer to purging of a fuel cell for the purpose of simplifying the discussion, it is within the scope of the present disclosure to utilize the purge systems and methods to purge all of the fuel cells of a fuel cell stack, such as all at once, individually, or in subsets of two or more fuel cells.

A consideration when purging the anode region of a fuel cell is that the anode region contains the fuel for the fuel cell. This fuel is often flammable and often has a commercial value that affects the overall efficiency of the fuel cell system. More specifically, fuel for fuel cells is often drawn from a fuel reservoir that must be periodically replenished and/or produced by a hydrogen-producing or other fuel processor associated with the fuel cell. Accordingly, excessive purging of the anode region of a fuel cell wastes fuel that otherwise could be used to produce an electric current.

Also, because the anode purge stream may be flammable, the fuel cell system may need to be designed or otherwise configured to accommodate this release of flammable gas, should it be present in a particular fuel cell system. Accordingly, the fuel cell system may include a fuel dilution system configured to receive the anode purge stream, and to dilute the fuel in the anode purge stream until the concentration of fuel in the anode purge stream is below the lower flammability limit (LFL) of the fuel. For example, the fuel dilution system may be configured to mix the anode purge stream with sufficient oxidant so as to form a non-flammable mixture having a concentration of fuel that is less than about 100%, 75%, 50%, or 25%, amongst others, of the lower flammability limit of the fuel. The fuel dilution system may be integral with, or downstream of, an anode purge system 100, which is described below.

FIG. 6 schematically shows a purge system 100 for regulating the emission of fluid from the anode region(s) 30 of a fuel cell 20 or fuel cell stack 24. System 100 also may be referred to herein as an anode purge system and/or as a purge assembly. System 100 may include an anode outlet, or release mechanism, 112 that is configured to emit the anode purge stream 54 from the anode region(s) of the fuel cell and/or fuel cell stack. The released anode purge stream may be used for any suitable purpose and/or disposed of in any suitable manner. Illustrative, non-exclusive examples include consuming the anode purge stream as a fuel stream for a burner or other heating assembly, mixing the anode purge stream with a cathode purge stream or other air source in a fluid dilution system, exhausting the anode purge stream to an exhaust burner, etc.

Illustrative, non-exclusive methods for purging the anode region of a fuel cell (or fuel cell stack) include emitting a purge stream on a continuous and/or periodic basis. Continuous purge streams are effective for removing gases from the anode region, although periodic purges may additionally or alternatively be used. During operation of a fuel cell, impurity gases (e.g., gases that are not consumed as reactants in the anode region) may build up in the anode region. This buildup, or increase in concentration, of impurity gases may affect the performance of the fuel cell. Maintaining a continuous flow of purge gas from the anode region prevents the accumulation of these impurity gases in the anode region. Typically, a continuous purge stream, or bleed stream, has a relatively low flow rate so as to reduce the amount of hydrogen gas or other fuel that is emitted with the purge stream and is thereby prevented from being utilized to produce an electric current in the fuel cell. A potential benefit of a continuous purge stream is that the purge assembly may require less complex controls and equipment because the purge stream may not be positively regulated and controlled.

An anode purge system 100 that is configured to emit fluid from the anode region on a continuous basis will typically include an anode outlet, or release mechanism, 112 that includes one or more restrictive orifices 104 of suitable cross-sectional area relative to the flow rate of hydrogen gas to the anode region to maintain the desired pressure and/or residence time of the hydrogen gas in the anode region. The orifice, when utilized, may have a fixed orifice size or an adjustable orifice size. When the fuel cell system includes or is in communication with a control system, such as control system 81, the control system may be adapted to selectively regulate the size of an adjustable orifice, such as via suitable control signals from the control system's controller 83.

An anode purge system that is configured to emit fluid from the anode region on a periodic basis will typically include an anode outlet 112 that includes a purge valve assembly 106 having one or more valves 108 that are adapted to permit periodic, or intermittent, releases of purge stream 54 from the anode region. The term “purge event” may be used to describe each of the periodic, or intermittent, releases of purge stream from the anode region. Purge stream 54 is not emitted from the anode region between these intermittent emissions. The term “purge cycle” may be used to describe the alternating periods in which purge stream 54 is emitted and then not emitted from an anode region of a fuel cell. The timing and/or duration of these releases may be selected or regulated via any suitable mechanism. In some embodiments, the timing and/or duration of each purge cycle and/or purge event, may be correlated with, or determined by, one or more operating parameters relating to the operation of the fuel cell (or fuel cell stack). When the fuel cell system includes or is in communication with a control system, such as control system 81, the control system may be adapted to selectively regulate at least one (or both) of the timing and frequency of purge events and/or the electrical output of and/or applied load to the stack during purge events.

Anode purge systems that are adapted to release, or emit, purge stream 54 on a periodic, or intermittent, basis may exhaust or otherwise release less hydrogen gas (or other fuel) than when purge stream 54 is emitted from the anode region on a continuous basis. However, in some embodiments such purge systems may be more complex and/or may require more components and/or control than a purge system that is adapted to release purge stream 54 on a continuous basis. Also the periodic releases of purge stream 54 may affect the pressure within the fuel cell (and thereby the performance of the fuel cell) and/or require the positive regulation of the electrical output of the fuel cell stack to offset the loss of pressure during the periodic purge from the anode region. The above-discussed illustrative examples of anode purge systems and methods are all within the scope of the present disclosure. Which of the disclosed system and methods is preferred for a particular application may tend to vary according to a variety of factors, which may include the fuel used in the fuel cell system, the size and/or capacity of the system, the desired efficiency of the system, the acceptable amount of components in the system, the complexity of the system, the acceptable cost of the system, the type of fuel cells being utilized, user preferences, etc.

As discussed below, it may be necessary or desirable to intermittently increase the flow rate of the purge stream 54 emitted through the anode outlet 112 so as to expel, through the anode outlet, a substantial portion of any liquid (e.g. water) that has collected in the anode flow field of the fuel cell. Generally, continuous bleed purge systems are not configured to emit a purge stream having a sufficient flow rate to expel a substantial portion of any liquid that has collected in the anode flow field through the anode outlet. Periodic purge systems may, during purge events, emit a purge stream having a flow rate that is greater in comparison to the flow rate of a purge stream from a continuous purge system due to cyclic changes in the gas pressure within the anode region during purge cycles. However, as with the continuous purge systems, these periodic purge systems generally do not emit a purge stream having a flow rate sufficient to expel a substantial portion of any liquid that has collected in the anode flow field through the anode outlet. Further, periodic purge systems may cause a buildup of impurity gases in the anode region between purge events, which may temporarily affect the fuel cell's ability to produce the desired electrical output, thus affecting the fuel cell system's ability to fully satisfy an applied load.

The present application discloses fuel cell systems 22 that are configured to intermittently increase the flow rate of the purge stream 54 so as to expel, from the anode region(s) 30 of a fuel cell 20 or fuel cell stack 24, a substantial portion of any liquid that has collected in the anode flow field(s) 88 of the fuel cell(s). When it is desired to expel liquid(s) from the anode flow field of a fuel cell, the fuel cell may be isolated from the applied load for a temporary, or momentary, period of time without substantially altering the flow rate of the fuel stream 66 delivered to the anode region via the anode inlet 110. Because a load is not being applied to the fuel cell during the isolation period, the consumption of hydrogen gas by the fuel cell is momentarily interrupted or otherwise reduced. The net effect of this interruption in the consumption of hydrogen gas is that an increased amount of hydrogen gas is present in the anode region of the fuel cell compared to the amount of hydrogen gas that was present when the fuel cell was in the non-isolated state. Expressed in slightly different terms, the ratio of the amount of hydrogen gas consumed in the fuel cell to the amount of hydrogen gas delivered to the fuel cell decreases as the fuel cell is transitioned from the non-isolated state to the isolated state even though the rate at which fuel is delivered to the fuel cell remains unchanged or at least substantially unchanged.

In fuel cells 20 that utilize a continuous purge system for purging fluid from the anode region, the delivery of excess hydrogen gas to the anode region 30 during the temporary isolation period will increase the gas pressure within the anode region, thus increasing the flow rate of fluid through the anode flow field(s) and through the anode outlet 112. In fuel cells that utilize a periodic purge system, the delivery of excess hydrogen gas during the temporary isolation period will increase the gas pressure within the anode region between purge events, thereby increasing the flow rate of fluid through the anode outlet during the subsequent purge event. Therefore, for fuel cells having either continuous or periodic purge systems, the temporary isolation period will cause the flow rate of the purge stream 54 emitted from the anode region to increase in magnitude.

Accordingly, it should be appreciated that a fuel cell 20 or fuel cell stack 24 may be configured for use in various operational states, including but not limited to, a non-isolated state and an isolated state. In the non-isolated state, a load may be applied to a fuel cell or fuel cell stack, and a fuel stream 66 may be delivered at a selected flow rate to the anode region(s) 30 of the fuel cell or fuel cell stack via the anode inlet(s) 110. A purge stream 54 consequently may be emitted from the anode outlet(s) 112 at a first resultant flow rate. In the isolated state, the fuel cell or fuel cell stack may be isolated from the load, and the fuel stream may be delivered to the anode region(s) at a flow rate that is the same or substantially the same as the flow rate for the corresponding non-isolated state. The purge stream consequently may be emitted from the anode outlet(s) at a second resultant flow rate that is greater in magnitude than the first resultant flow rate. It should also be appreciated that when a fuel cell or fuel cell stack is configured in the non-isolated state, the isolated state, or both the non-isolated state and the isolated state, the anode outlet(s) may be configured to either continuously or periodically emit the purge stream from the anode region(s).

A fuel cell 20 may be temporarily isolated from the load for a period of time sufficient to cause the flow rate of the purge stream 54 to increase to a magnitude that causes a substantial portion of any liquid that has collected in the anode flow field 88 to be expelled from the anode region 30. For both continuous and periodic purge systems, and depending on the flow rate of the fuel stream 66, the isolation period may last for only a brief, or momentary, period of time (such as less than 10 seconds, less than 5 seconds, less than 3 seconds, 10-5 seconds, 7-3 seconds, 1-4 seconds, 0.5-2 seconds, less than one second, less than 0.5 seconds, etc.), provided the period of time is sufficient to cause the flow rate of the purge stream to increase to a magnitude that causes a substantial amount of any liquid that has collected in the anode flow field to be expelled from the anode region. The magnitude should be sufficient to expel enough liquid so as to prevent excess liquid from collecting in the anode flow field and thereby inhibiting the flow of gases through the anode flow field. For example, the flow rate of the purge stream may increase to a magnitude sufficient to expel from the anode region at least 30%, 40%, 50%, 60%, 70%, 80%, 90%, 95%, etc. of any liquid that has collected in the anode flow field during use of the fuel cell in the non-isolated state.

A fuel cell 20 or fuel cell stack 24 may be temporarily isolated from the applied load by the power management module 77 and/or control system 81. In other words, the control system and/or power management module may electrically disconnect, or isolate, the fuel cell, fuel cells, or the entire fuel cell stack from the applied load for the momentary period of time, without altering or without substantially altering, the flow rate of the fuel stream delivered to the anode region of each isolated fuel cell. During this momentary transition to an isolated state, the flow rate of fuel expelled from the anode region will increase, as discussed herein, due to the reduction in fuel consumption because of the load isolation. After this momentary period, the power management module and/or control system automatically electrically reconnects the fuel cell, fuel cells, or the entire fuel cell stack to the applied load, thereby returning the fuel cell(s) to the non-isolated state and resuming the consumption of fuel at a rate consistent with, or even greater than, prior to the transition to the isolated state.

As an illustrative, non-exclusive example, controller 83 may be configured to change the configuration of an individual fuel cell, some but not all of the fuel cells in a fuel cell stack, or all of the fuel cells in a fuel cell stack, from a non-isolated state to the isolated state for a momentary period of time. As described above, the momentary period of time may be selected to ensure that the flow rate of the purge stream emitted from the anode region of each isolated fuel cell increases in magnitude to expel from the anode region of each isolated fuel cell a substantial portion of any liquid that has collected in the anode flow field during use of the now isolated fuel cells in the non-isolated state. The controller may also be configured to (automatically) change the configuration of each isolated fuel cell from the isolated state to the non-isolated state after the momentary period of time has ended. Finally, the controller may be programmable and/or otherwise automated, such as via an external or integrated user interface, stored programming, etc.

The power management module 77 and/or control system 81 may temporarily isolate a fuel cell 20 or fuel cell stack 24 from the applied load on a periodic basis, such as during periodic isolation events. For example, controller 83 may be configured to momentarily change the configuration of any particular fuel cell, subset of fuel cells, or the entire fuel cell stack in the fuel cell system from the non-isolated state to the isolated state on a periodic basis that is frequent enough to substantially reduce the possibility that the anode region 30 (e.g. the anode flow field 88) of the fuel cell(s) will flood with accumulated liquid. For fuel cell systems having a plurality of fuel cells (such as those fuel cells in one or a plurality of fuel cell stacks), the controller may be configured to alternate which of the plurality of fuel cells (or which of the plurality of fuel cell stacks) are isolated during each periodic isolation event, and to cycle through the plurality of fuel cells during subsequent isolation events. During each periodic isolation event, the controller thus may be configured to momentarily isolate one, more than one but not all, or all of the fuel cells in a fuel cell stack or fuel cell system.

The power management module 77 and/or control system 81 may temporarily isolate a fuel cell 20 or fuel cell stack 24 from the applied load (such as by momentarily changing the configuration of any particular fuel cell in the fuel cell system from the non-isolated state to the isolated state) in response to the occurrence of an event. As an illustrative, non-exclusive example, the event may be a period of elapsed time, such as since the last purge event, the last transition of one or more fuel cells (or the entire fuel cell stack) to or from an isolated state, since use of the fuel cell(s) in the non-isolated state began, etc. In such a configuration, the power management module and/or control system may include or be in communication with a timer that measures the elapsed time, with the fuel cell, fuel cells, and/or the fuel cell stack being transitioned to the isolated state for the momentary period of time and then returned to the non-isolated state. In some embodiments, the timer or elapsed time measurement may then be reset, although this is not required to all embodiments. As another illustrative, non-exclusive example, the event may be a reduction in the performance of a fuel cell or fuel cell stack that may correspond to an excess of accumulated liquid in the anode flow field(s) of a fuel cell or fuel cell stack. As discussed above, the control system may include one or more sensors 75 for measuring and/or monitoring various operating parameters (such as temperature, pressure, flow rate, electrical output, current, voltage, capacity, fuel utilization, composition, etc.) and communicating these values to the controller 83 via communication link(s) 85. The operating parameter(s) measured by the sensors and communicated to the controller may correspond to the overall performance of the entire fuel cell system, or of individual fuel cells or fuel cell stacks in the fuel cell system. If the measured value of an operating parameter communicated to the controller is above or below a threshold value, thus indicating a reduction in performance of one or more fuel cells, then the controller may be configured to momentarily isolate the one or more fuel cells, or the entire fuel cell stack, from the applied load. For example, if the measured value of the electrical output from a fuel cell or fuel cell stack is below a threshold value, then the fuel cell or the fuel cell stack may be temporarily isolated from the load.

During the temporary isolation period, oxidant 44 may or may not continue to be delivered to the cathode region 32. If the controller 83 configures a fuel cell 20 to be in the isolated state, the controller may also cause the fuel cell system to cease or reduce the delivery of oxidant to the cathode region. Alternatively, the flow rate of the oxidant stream delivered to the cathode region may not be altered or substantially altered during the momentary isolation period and/or may be increased during the temporary isolation period.

The fuel cell system 22 such as via power management module 77 and/or control system 81, further may be configured to isolate a fuel cell 20 or fuel cell stack 24 from the applied load (thereby increasing the flow rate of the purge stream 54 from the fuel cell or fuel cell stack) without affecting the fuel cell system's ability to satisfy an applied load. During the isolation period, each isolated fuel cell is not being urged to produce an electrical output to satisfy the applied load. If less than all of the fuel cells in the fuel cell system are isolated from the load during a particular isolation event, the other non-isolated fuel cells may be capable of generating sufficient electrical output to satisfy the applied load. However, if the electrical output generated by any non-isolated fuel cells does not satisfy the applied load, a battery or other energy-storage device 78 may be used satisfy this portion. The energy storage device may thus be used to ensure that the power (or electrical output) provided to the energy-consuming device(s) that is (are) applying an electrical or other load to the fuel cell system is not interrupted even though one or more fuel cells (or even the entire fuel cell stack) are momentarily electrically isolated or otherwise disconnected from the applied load. Due to the brief duration of the isolation period, the stored power of the energy-storage device is not likely to be significantly affected, and the device may be recharged upon reconnection of the isolated fuel cells to the applied load after the momentary isolation period.

It should be appreciated that the above described systems and methods may be performed by actuating one or more electrical switches that temporarily isolate a fuel cell or fuel cell stack from an applied load, and without the need for pumps, valve controls, etc. to cause the increase in fuel flow rate to remove accumulated water or other liquid from the anode region(s). However, other methods for purging liquid from the anode region 30 of a fuel cell 20 may utilize the control and/or regulation of pumps, valves, etc. These methods include: (a) temporarily increasing the flow rate of the fuel stream to the anode region to cause an increase in the flow rate of the purge stream 54; (b) temporarily isolating the fuel cell from the applied load, while increasing the flow rate of the fuel stream, to cause an increase in the flow rate of the purge stream; or (c) temporarily reducing or ceasing the flow rate of the oxidant stream to the cathode region, while continuing to deliver the fuel stream to the anode region at a decreased flow rate, substantially the same flow rate, or an increased flow rate, to cause an increase in the flow rate of the purge stream. Systems that perform these methods may include a control system for controlling and/or regulating the temporary changes in the flow rate of the fuel stream and/or oxidant stream, and/or the temporary isolation of the fuel cell from the applied load. Any of these methods and systems may be used with fuel cell systems having either continuous or periodic purge systems. Further, the purge events performed during these methods, or by these systems, may occur on a periodic basis, or in response to the occurrence of an event, according to the above disclosure.

### INDUSTRIAL APPLICABILITY

The fuel cell systems and methods of operating the same that are disclosed herein are applicable to the fuel cell industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A method of purging liquid from an anode flow field of at least one of one or more fuel cells, each of the one or more fuel cells having an anode region and a cathode region, the method comprising:
electrically coupling each of the one or more fuel cells to an energy consuming device that applies an applied load to the one or more fuel cells;
delivering a fuel stream to the anode region, and an oxidant stream to the cathode region, of each of the one or more fuel cells, whereby a purge stream is emitted from the anode region of each of the one or more fuel cells, and the one or more fuel cells generate an electrical output that satisfies at least a portion of the applied load; and
electrically isolating at least one of the one or more fuel cells from the applied load for a temporary period of time without substantially altering the flow rate of the fuel stream delivered to the anode region of each isolated fuel cell, wherein the period of time is sufficient to cause the flow rate of the purge stream emitted from the anode region of each isolated fuel cell to increase in magnitude to expel from the anode region of each isolated fuel cell a substantial portion of any liquid that has collected in the anode flow field of each isolated fuel cell.

2. The method of claim 1, further comprising the step of automatically reconnecting the applied load to the at least one isolated fuel cell after the temporary isolation period.

3. The method of claim 1, wherein during the temporary isolation period, at least a portion of the applied load is not satisfied, and the method further comprises coupling an energy-storage device to the energy consuming device to temporarily satisfy the unsatisfied portion of the applied load.

4. The method of claim 3, further comprising the step of recharging the energy-storage device.

5. The method of claim 1, wherein the one or more fuel cells includes a plurality of fuel cells in a fuel cell stack.

6. The method of claim 5, wherein the step of electrically isolating at least one of the one or more fuel cells from the applied load for a temporary period of time includes electrically isolating more than one of the plurality of fuel cells in the fuel cell stack from the applied load for a temporary period of time without substantially altering the flow rate of the fuel stream delivered to the anode region of each of the isolated fuel cells, and wherein at least one of the plurality of fuel cells in the fuel cell stack is not isolated from the applied load during the temporary isolation period.

7. The method of claim 5, wherein the step of electrically isolating at least one of the one or more fuel cells from the applied load for a temporary period of time includes electrically isolating each of the plurality of fuel cells in the fuel cell stack from the applied load for a temporary period without substantially altering the flow rate of the fuel stream delivered to the anode region of each of the plurality of fuel cells.

8. The method of claim 1, wherein the step of electrically isolating the at least one of the one or more fuel cells from the energy consuming device for a temporary period of time is performed on a periodic basis.

9. The method of claim 1, wherein the step of electrically isolating the at least one of the one or more fuel cells from the energy consuming device for a temporary period of time is performed in response to the occurrence of an event.

10. The method of claim 9, wherein the method includes measuring a value of a selected operating parameter of the fuel cell system, and further wherein the event is when the value is above or below a predetermined threshold value.

11. The method of claim 10, wherein the selected operating parameter is the electrical output of at least one of the one or more fuel cells, and wherein the measured value of the electrical output is below the predetermined threshold value.

12. The method of claim 1, wherein the purge stream is continuously emitted from the anode region when the one or more fuel cells are in the isolated state and non-isolated state.

13. The method of claim 1, wherein the purge stream is periodically emitted from the anode region when the one or more fuel cells are in the isolated state and the non-isolated state.

14. The method of claim 1, wherein during the temporary isolation period, the flow rate of the oxidant stream delivered to the cathode region of each isolated fuel cell is not substantially altered.

15. The method of claim 1, wherein the temporary period of time that the at least one of the one or more fuel cells is isolated from the applied load is selected from the group consisting of: less than 10 seconds, less than 5 seconds, less than 3 seconds, 10-5 seconds, 7-3 seconds, 1-4 seconds, and 0.5-2 seconds.

16. A fuel cell system, comprising:
a fuel cell configured to consume a fuel and an oxidant to generate an electrical output when an applied load is applied to the fuel cell by an energy consuming device, the fuel cell comprising an anode region including an anode inlet configured to receive a fuel stream into the anode region, an anode flow field configured to transport fuel through portions of the anode region, and an anode outlet configured to emit a purge stream from the anode region, the fuel cell being configured for use in at least:
a non-isolated state, wherein the load is applied to the fuel cell, and the fuel stream is delivered to the anode inlet at a selected flow rate, and whereby the purge stream is emitted from the anode outlet on at least one of an intermittent and a periodic basis; and
an isolated state, wherein the fuel cell is isolated from the applied load, and the fuel stream is delivered to the anode inlet flow at a rate that is at least substantially the same as the selected flow rate, and whereby the purge stream is emitted from the anode outlet on at least one of an intermittent and a periodic basis; and
a controller configured to change the configuration of the fuel cell from the non-isolated state to the isolated state for a momentary period of time and then return the fuel cell to the non-isolated state, whereby the period of time is sufficient to cause the flow rate of the purge stream to increase in magnitude to expel, through the anode outlet, a substantial portion of any liquid that has collected in the anode flow field.

17. The fuel cell system of claim 16, wherein the momentary period of time the fuel cell is configured in the isolated state is selected from the group consisting of: less than 10 seconds, less than 5 seconds, less than 3 seconds, 10-5 seconds, 7-3 seconds, 1-4 seconds, and 0.5-2 seconds.

18. The fuel cell system of claim 16, further comprising an energy-storage device configured to satisfy at least a portion of the applied load that is not satisfied by the fuel cell during the momentary period of time.

19. The fuel cell system of claim 16, wherein the fuel cell system includes a plurality of fuel cells in a fuel cell stack, and further wherein the fuel cell is one of the plurality of fuel cells in the fuel cell stack.

20. The fuel cell system of claim 19, wherein the controller is configured to change the configuration of some but not all of the plurality of fuel cells from the non-isolated state to the isolated state for the momentary period of time.

21. The fuel cell system of claim 19, wherein the controller is configured to change the configuration of all of the plurality of fuel cells from the non-isolated state to the isolated state for the momentary period of time.

22. The fuel cell system of claim 16, wherein the controller is configured to momentarily change the configuration of the fuel cell from the non-isolated state to the isolated state on a periodic basis.

23. The fuel cell system of claim 16, wherein the controller is configured to momentarily change the configuration of the fuel cell from the non-isolated state to the isolated state in response to the occurrence of an event.

24. The fuel cell system of claim 23, further comprising a sensor that is in communication with the controller and is configured to measure a selected operating parameter of the fuel cell system, wherein the event includes measuring a value of the operating parameter that is above or below a predetermined threshold value.

25. The fuel cell system of claim 24, wherein the selected operating parameter is the electrical output of the fuel cell, and wherein the measured value of the electrical output is below the predetermined threshold value.

26. The fuel cell system of claim 16, wherein the anode outlet is configured to continuously emit the purge stream from the anode region when the fuel cell is configured in the non-isolated state, the isolated state, or both the non-isolated sate and the isolated state.

27. The fuel cell system of claim 16, wherein the anode outlet is configured to periodically emit the purge stream from the anode region when the fuel cell is configured in either the non-isolated state, the isolated state, or both the non-isolated state and the isolated state.

28. The fuel cell system of claim 16, wherein the fuel cell further comprises a cathode region configured to receive an oxidant stream, and wherein during the momentary period of time that the fuel cell is configured in the isolated state, the flow rate of the oxidant stream delivered to the cathode region is not reduced.

29. A fuel cell system, comprising:
a fuel cell configured to consume a fuel and an oxidant to generate an electrical output when an applied load is applied to the fuel cell by an energy consuming device, the fuel cell comprising an anode region including an anode inlet configured to receive a fuel stream into the anode region, an anode flow field configured to transport fuel through portions of the anode region, and an anode outlet configured to emit a purge stream from the anode region; and
means for expelling liquid from the anode region by periodically isolating the fuel cell from the applied load for a momentary period of time while continuing to deliver fuel to the anode inlet, wherein the momentary period of time is sufficient to cause an increase in the flow rate of the purge stream to expel accumulated liquid from the anode flow field through the anode outlet.

30. The fuel cell system of claim 29, wherein the momentary period of time the fuel cell is configured in the isolated state is selected from the group consisting of: less than 10 seconds, less than 5 seconds, less than 3 seconds, 10-5 seconds, 7-3 seconds, 1-4 seconds, and 0.5-2 seconds.
